(19) United States
(12) Patent Application Publication
(10) Pub. No.: US 2026/0122319 A1
(43) Pub. Date: Apr. 30, 2026

(54) SYSTEMS AND METHODS TO AUTHORIZE DIGITAL WALLET TRANSACTIONS FOR OFFERINGS PRESENTED IN DIGITAL CONTENT

(71) Applicant: Adeia Guides Inc., San Jose, CA (US)

(72) Inventors: Serhad Doken, Bryn Mawr, PA (US); Ning Xu, Irvine, CA (US); Tao Chen, Palo Alto, CA (US)

(21) Appl. No.: 18/933,294

(22) Filed: Oct. 31, 2024

(51) Int. Cl. H04N 21/478; H04N 21/258; H04N 21/441; H04N 21/4725; H04N 21/61

(52) U.S. Cl. CPC H04N 21/47815; H04N 21/25816; H04N 21/441; H04N 21/4725; H04N 21/6106

(57) ABSTRACT

Methods and systems are disclosed herein for techniques for authorizing digital wallet transactions for offerings presented in digital content. The system identifies one or more devices in a vicinity of a display of a video stream. A product is displayed in the video stream. The system selects a device and identifies data including a product identifier for the product displayed in the video stream, a provider identifier for a provider associated with the product, an account identifier associated with the selected device, and an authorized account token linking an authorization server to the video stream provider. The system causes encoding, based at least in part on the identified data, of a message in a near-field communication (NFC) data exchange format. The system causes transmission of the encoded message to the device via a non-NFC network, receives authorization of a transaction from the authorization server, and causes display, on the device, of a confirmation for the transaction.

### BACKGROUND

The present disclosure relates to content delivery, and more particularly to systems and related processes for securely communicating and authorizing transactions associated with delivered content.

### SUMMARY

Shoppable videos have been gaining momentum steadily and are expected to be pervasive within the next decade. For instance, a shoppable video, or other content, facilitates discovery of products in the content and enables a transaction, e.g., through links and metadata within the content. Most devices for shared use are primarily consumption devices without biometric protection or advanced security for transactions. When viewing shoppable videos on community devices that are accessible to multiple users in a home or shared physical space, e.g., televisions, direct purchasing has security issues. For instance, without biometric protection, anyone in the community viewing the shared device could execute a purchase without confirming their identity through advanced authorization, creating opportunities for invalid purchases.

In some approaches, service providers display website address, e.g., a uniform resource locator (URL), links, or product information, within shoppable videos. In such approaches, to navigate to the products shown on-screen, users manually enter website information by typing the link or product information into a web browser on a separate device. In another approach, service providers display quick response (QR) codes within shoppable videos. In this approach, to navigate to the products shown on-screen, users scan QR codes with a separate device from the device they are consuming the video on to redirect them to the shopping website. In another approach, integrated near field communications (NFC) readers may be built into a television or display device systems so that users can tap the NFC readers on their display device with a device (e.g., a smartphone) to authenticate purchases of products using a digital wallet on the device.

Deficiencies exist in such approaches, however. Displaying website links or product information on-screen is a deficient approach because, for example, mistyped URL links occur when employing manual entry. If a URL or product information is not typed in correctly when it is shown on-screen, the user will not be able to navigate to the website and buy the intended product. The QR code approach is deficient because QR codes are visible to anyone who can view the display device, giving access to potential bad or unintended actors who may interfere with transactions. Further, QR codes can maliciously gather data from users that the providers of the QR codes are not supposed to have and make fraudulent transactions, causing security and potentially identity fraud issues. Using an integrated NFC reader is deficient because it is for nearby communications. Moreover, it may be technologically difficult and prohibitively expensive for the average consumer to install an integrated NFC reader for each of their televisions. It may also be cumbersome or infeasible for new display devices to be designed and manufactured with built-in NFC readers, and which still would not solve the issues of requiring physical proximity and/or a tap to an NFC reader.

To help address these problems, systems and methods are provided herein for securely authorizing digital wallet purchases associated with “shoppable” content. In some embodiments, a disclosed service offers a secure-digital wallet-based direct purchase option and aims to create a digital offer of a product or service, price, and delivery timeframe for a select and authorized consumer to consider, accept, and securely authorize payment form if desired.

In some embodiments, the system identifies one or more devices in a vicinity of a display of a video stream (which is provided by a video stream provider) that is currently displaying a product. In some implementations, the system then selects a device of the one or more devices in the vicinity of the display of the video stream. In some embodiments, the system identifies data including a product identifier for the product displayed in the video stream, a provider identifier for a provider associated with the product, an account identifier associated with the device, and an authorized account token linking an authorization server to the video stream provider. In some embodiments, the system causes encoding of a message in a near-field communication (NFC) data exchange format. In some examples, the encoded message includes the identified data. In some embodiments, the system then causes transmission of the encoded message to the device via a non-NFC network, receives authorization of a transaction from the authorization server, and causes to display, on the device, a confirmation for the transaction.

Such aspects may offer consumers, for example, an electronic gift basket including the desired product. This might be, for instance, a pre-packaged offer with multiple products that consumers cannot modify. Some carts may display the additional items, while others may hide them until physical delivery. The pre-packaged bundle may minimize distractions from alternatives and choices that can be added to a cart, or from the potential to remove the original product that the consumer intended to buy, allowing for service providers to finalize more transactions. Further, bundling different items allows service providers to offer combinations of products based on their current inventory, specials, trends, and/or certain products that they are trying to introduce or test on a new market.

In some embodiments, the encoded message also includes a video clip. In some examples, the video clip is personalized based on one of more of stored user preferences for a user account associated with the device, products in the video stream, people in the video stream, the provider of the video stream, the provider associated with the product, or inventory levels at the provider associated with the product. In some embodiments, the system pauses or plays the video clip in response to receiving a selection of a user interface option on the device to pause or play the video clip. In some embodiments, the system transmits the encoded message to a second device via a messaging service after receiving, on the device, a selection of a user interface option to share the encoded message with a second device.

In some embodiments, a payload of the encoded message includes the product identifier, the provider identifier, and an account identifier token associated with the account identifier associated with the device. In some implementations, the encoded message has an NFCTypeNameFormat function set to be NFCTypeNameFormat. empty, and a user activity type set to be NSUserActivity TypeBrowsingWeb. In some embodiments, the system causes transmission of the encoded message to the device and by simulating an NFC connection over the non-NFC network. For instance, an NFC connection uses NFC protocols to authenticate a transaction. By simulating an NFC connection (using a network that is not part of the NFC communication) a transaction over, e.g., Wi-Fi, Bluetooth, IP, and/or other network connections, can adopt the same or similar security measures of an NFC transaction, along with the familiar interface of an electronic wallet from, e.g., Apple Pay or Google Pay. For instance, in some embodiments, the system may generate the authorized account token (e.g., an AuthorizedDigitalWalletToken) based on the credentials. In some examples, the authorized account token identifies the video service.

Such aspects ensure that products are both accurately and securely transmitted for authorized purchases, without malicious actors taking private information from prospective buyers, and without needing the close proximity of an NFC tap or additional NFC hardware for display devices.

### BRIEF DESCRIPTION OF THE DRAWINGS

The present disclosure, in accordance with one or more various embodiments, is described with reference to the following figures. The drawings are provided for purposes of illustration only and merely depict typical or example embodiments. These drawings are provided to facilitate an understanding of the concepts disclosed herein and do not limit the breadth, scope, or applicability of these concepts. It should be noted that for clarity and ease of illustration these drawings are not necessarily made to scale.

FIG. 1 is an illustrative example of securely communicating and authorizing transactions associated with digital content presented on a display device, in accordance with some embodiments of the present disclosure;

FIG. 2 is a sequence diagram of an illustrative process for securely communicating and authorizing transactions associated with digital content presented on a display device, in accordance with some embodiments of the present disclosure;

FIG. 3 is a sequence diagram of an illustrative process for securely communicating and authorizing transactions associated with digital content presented on a display device using voice signature authentication, in accordance with some embodiments of the present disclosure;

FIG. 4 is a flowchart of an illustrative process for securely communicating and authorizing transactions, in accordance with some embodiments of the present disclosure;

FIG. 5 is a flowchart of an illustrative process for preparing an encoded message for transmission, in accordance with some embodiments of the present disclosure;

FIG. 6 is a flowchart of an illustrative process for sharing the encoded message with a second device, in accordance with some embodiments of the present disclosure;

FIG. 7 is a flowchart of an illustrative process for receiving credentials for a video stream provider, in accordance with some embodiments of the present disclosure;

FIG. 8 is a block diagram of an illustrative media device, in accordance with some embodiments of this disclosure;

FIG. 9 is a diagram of an illustrative streaming system, in accordance with some embodiments of this disclosure; and

FIG. 10 is a flowchart of an illustrative process for securely communicating and authorizing transactions, in accordance with some embodiments of the present disclosure.

### DETAILED DESCRIPTION OF EMBODIMENTS OF THE DISCLOSURE

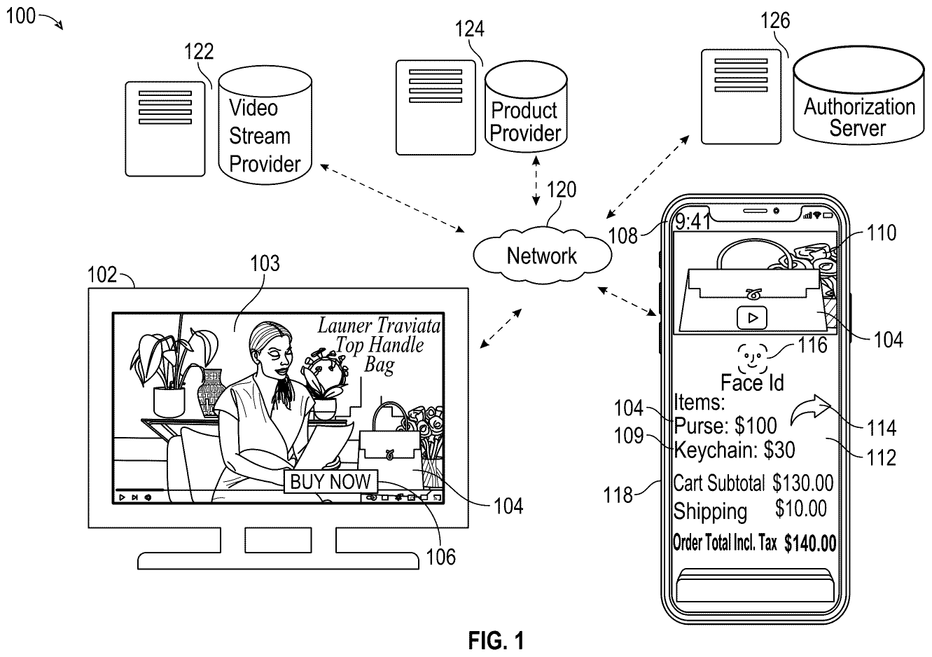

FIG. 1 is an illustrative example of securely communicating and authorizing transactions associated with digital content presented on a display device, in accordance with some embodiments of the present disclosure. In some embodiments, system 100 includes display device 102 (e.g., a television); video stream 103; product 104 (e.g., a purse); first user interface option 106 (e.g., a selectable button with the text “BUY NOW”); user device 108 (e.g., a smart phone); related second product 109; video clip 110 featuring product 104; pricing information for the prepackaged digital cart 112; option to share the digital cart 114; transaction authorization user interface option 116; digital cart 118; network 120; video stream provider 122; product provider 124; and authorization server 126. In some examples, network 120 is the internet, a cellular network, or any suitable network. System 100 may include additional servers, devices, and/or networks. For example, functionality of each of video stream provider 122, product provider 124, and authorization server 126 may be shared between several servers, providing a cloud computing solution. In some examples, video stream provider 122 is an over-the-top (OTT) video delivery service server that provides video content or streams over a network (e.g., network 120) to user computing devices (e.g., smartphones, computers, laptops, kiosks, televisions, display devices, etc.) for streaming (e.g., on-demand, IPTV, FAST TV, local storage, downloading, or other media consumption operations). In some embodiments, video may be provided via cable, satellite, over-the-air, and/or via other broadcast media.

In some embodiments, video stream provider 122 delivers content in the form of video streams over a communications path through network 120 to display device 102. In some embodiments, display device 102 presents video stream 103 depicting product 104 and first user interface option 106. In some embodiments, video stream provider 122 associates product 104 with first user interface option 106 by linking product 104 to first user interface option 106, e.g., using metadata and/or a manifest file. In some embodiments, video stream provider 122 ties product 104 to first user interface option 106 by running a computer vision algorithm on video stream 103 and matching found objects with a product provider selling the found objects. In some embodiments, video stream provider 122 associates product 104 with first user interface option 106 by selecting artificial intelligence (AI) and/or machine learning (ML) image classification models, for example, TensorFlow, TensorFlow Lite, or ONNX, for video stream 103 and using the selected classification models to identify objects within the video stream. In some embodiments, the image classification is performed by display device 102. In some embodiments, the image classification is performed by one or more servers of video stream provider 122. In some embodiments, bounding box coordinates for each object, classifiers, time stamps, and more are sent between video stream provider 122 and display device 102 via network 120. Updates and downloads of the AI models are done in band in some examples, and out-of-band in other examples. In some embodiments, video stream 103 is analyzed during rendering, and if an object is detected, it is linked as a product to a user interface option (e.g., product 104) to first user interface option 106. In some embodiments, video stream 103 is analyzed by an AI model at video stream provider 122, and the metadata resulting from the AI model is sent to display device 102. In some embodiments, multiple AI models are chained to process video stream 103 but look for different objects or link to different URLs. In some implementations, the AI models are serialized, but there are also parallelized implementations where video stream 103 is split into one stream per vendor for object recognition. The detected object metadata information can be sent in-band or out-of-band or both.

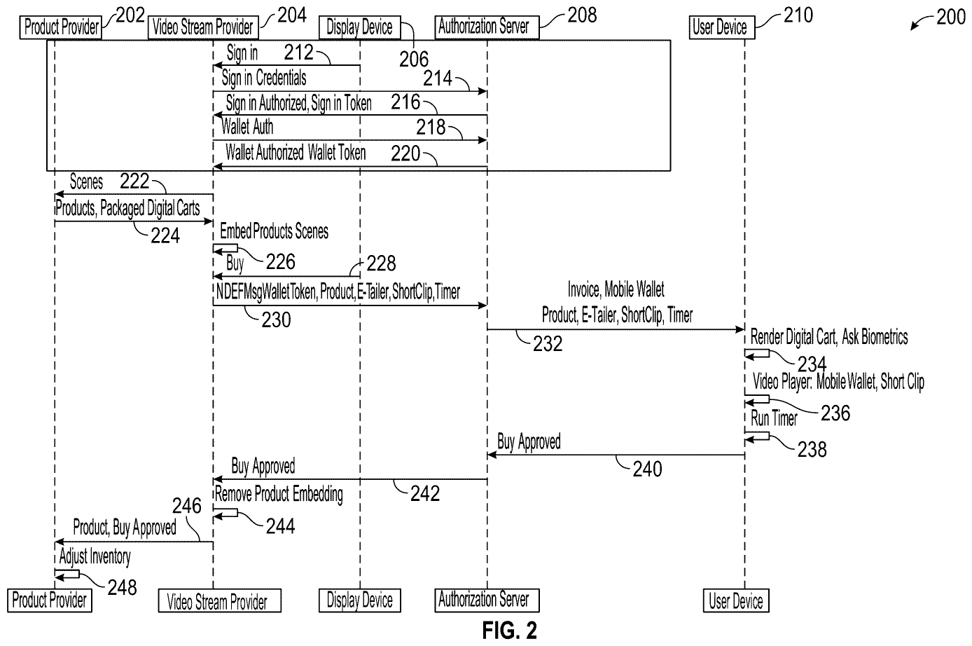

In some embodiments, display device 102 receives a selection of first user interface option 106 over network 120, for example, from a remote control connected to display device 102, or from another device. In some examples, display device 102 continues to display video stream 103 without displaying a webpage related to product 104 after receiving selection of first user interface option 106 over network 120. In some examples, video stream provider 122 does not direct user device 108 to a webpage related to product 104 after receiving selection of first user interface option 106 over network 120. In some implementations, if display device 102 does not receive a user selection of first user interface option 106, first user interface option 106 expires and is removed from the video stream after a predetermined time period, as described further below with reference to FIG. 2. In some embodiments, first user interface option 106 is presented at the end of video stream 103 (or at the end of a segment of video stream 103) as a call-to-action cart.

In some embodiments, network 120 is a non-NFC network, e.g., a path that does not use NFC hardware to communicate such as Wi-Fi, Bluetooth, cellular 5G/4G/LTE, Internet Protocol (IP), radio frequency (RF), and/or other network connections outside of NFC communications.

Near field communication (NFC) is a short-range wireless communication technology that allows for the exchange of data between two devices within close proximity, typically within 10 cm. In the context of mobile payments, NFC enables users to make transactions by tapping their mobile device on an NFC-enabled payment terminal, such as a point-of-sale (POS) system or an ATM. The process begins with the user's mobile device, which contains an NFC chip and antenna. When the user taps the phone on the payment terminal, the NFC chip in the phone creates a magnetic field that induces a current in the terminal's coil. The NFC-enabled terminal then communicates with the mobile device via the NFC chip to initiate the payment process. This involves authenticating the user's identity, verifying their account balance, and processing the transaction. The payment data is typically stored on a secure element, such as an embedded secure element (eSE) or a trusted service manager (TSM), within the mobile device. The eSE/TSM stores sensitive information, including encryption keys, certificates, and secure authentication protocols.

Once the user's identity has been verified, the terminal sends a command to the mobile device to authorize the payment amount. The mobile device then communicates with the payment processor, such as Visa or Mastercard, to initiate the payment transaction. This process involves encrypting the payment data and transmitting it to the payment processor for verification and settlement. If the transaction is approved, the payment processor sends a confirmation message back to the terminal, which then notifies the user that the payment has been successful. NFC-based mobile payments may rely on industry standards such as ISO 7816-4 and EMVCo for technical specifications for secure transaction processing.

As stated previously, NFC is restrictive at least due to the necessary hardware (e.g., a chip reader in addition to an NFC-enabled mobile device), as well as the requisite proximity needed for the “tap” to authenticate. By using a non-NFC network, while simulating an NFC-style transaction, an embodiment can implement NFC-like security and privacy without needing additional equipment and/or the proximity needed to tap a display device to carry out a transaction.

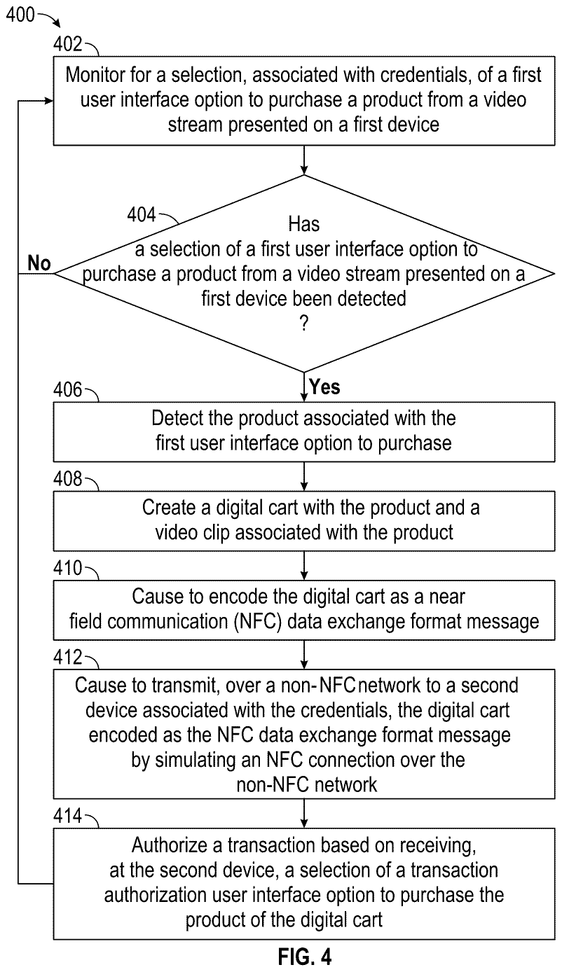

In some implementations, video stream provider 122 identifies data including a product identifier for the product 104, a product provider identifier for product provider 124, an account identifier associated with user device 108, and an authorized account token linking authorization server 126 to video stream provider 122. In some embodiments, video stream provider 122 encodes a message including the above data in an NFC data exchange format. In some embodiments, video stream provider 122 transmits the encoded message, over network 120, to user device 108, by simulating an NFC connection over network 120. In some embodiments, simulating the NFC connection over network 120 involves transmitting the digital cart the same way data would be transmitted using an NFC tap, but without tapping the user device 108 to a special hardware piece of display device 102. The process of encoding the message and transmitting the message by simulating an NFC connection over network 120 is described further below with reference to FIG. 4.

In some implementations, the identified data in the message also includes information, e.g., a second product identifier, for related second product 109 related to product 104. In some embodiments, when user device 108 receives the message, video stream provider 122 presents or displays, on the user interface of user device 108, digital cart 118. In some embodiments, digital cart 118 includes product 104, video clip 110, pricing information about product 104, pricing information about a related second product 109, pricing information for the prepackaged digital cart 112, option to share the digital cart 114, and transaction authorization user interface option 116. In some examples, the products in digital cart 118 cannot be modified or removed via the user interface of user device 108.

In some embodiments, video clip 110 is personalized based on stored user preferences for a user account associated with user device 108. In some examples, the stored user preferences include past purchase history via the content service provider associated with video stream provider 122 that is delivering video stream 103 at display device 102. In some embodiments, video clip 110 is personalized based on a portion of the video stream surrounding a timepoint in video stream 103 when the selection of the first user interface option 106 to purchase was received. In some embodiments, video clip 110 is personalized based on products in video stream 103, brands in video stream 103, locations depicted in video stream 103, and people in video stream 103. In some embodiments, video clip 110 is personalized based on the content service provider associated with video stream provider 122 that is delivering video stream 103. In some embodiments, video clip 110 is personalized based on product provider 124 selling product 104 and related second product 109 and inventory levels at the product provider 124. In some embodiments, different product providers are selling product 104 and related second product 109. In some embodiments, video clip 110 may be used to validate a transaction or an intent to purchase.

In some embodiments, product 104 and related second product 109 in digital cart 118 are chosen based on the product in video stream 103 shown at a timepoint in video stream 103 when selection of first user interface option 106 to purchase was received. In some embodiments, product 104 and the related second product 109 in digital cart 118 are chosen based on other products in video stream 103, products associated with the people in the video stream, brands in video stream 103, locations depicted in video stream 103, people in video stream 103, or stored user preferences for a user account associated with user device 108. In some examples, the stored user preferences include past purchase history via the content service provider associated with video stream provider 122 that is delivering video stream 103 at display device 102. In some embodiments, product 104 and the related second product 109 in digital cart 118 are chosen based on the product provider 124 selling the product and the related second product and inventory levels at product provider 124.

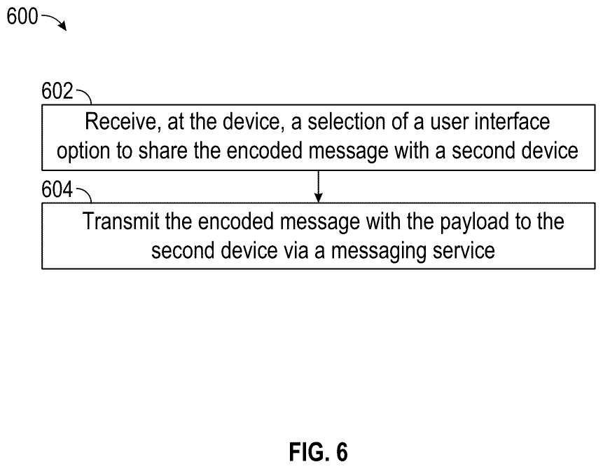

In some embodiments, video stream provider 122 receives selection of an option to share a message with similar data to a second device so the second device can display digital cart 118 and selections of options to play or pause video clip 110 on the second device, as described further below with reference to FIG. 6. In some embodiments, video stream provider 122 receives verification on user device 108 (e.g., face identification) via transaction authorization user interface option 116 and transmits the verification over network 120 to authorization server 126 to confirm the authorization to purchase digital cart 118. In some embodiments, after purchase authorization is completed, video stream provider 122 transmits purchase information to product provider 124. In some embodiments, product provider 124 is controlled by the seller or provider of the products in the digital cart, and the purchase information transmitted to product provider 124 allows inventory stock information to be updated at the seller and initiates the process of packaging and shipping the products to address information associated with user device 108. In some embodiments, if purchase authorization is not received at user device 108, digital cart 118 expires and is removed from user device 108 after a predetermined time period. In some embodiments, during the period that biometrics approval is impending, video clip 110 plays in a loop by invoking the default media player resident in user device 108 until the authorization is received or digital cart 118 expires.

In some embodiments, an application, e.g., a specialized shopping app, for example, Shop Samsung, on user device 108 will be pushed a notification including digital cart 118, video clip 110, and/or a timer parameter. In some examples, the notification will be displayed on user device 108 immediately but will expire when the timer parameter expires. In some examples, user device 108 receives a selection of the notification and launches the application; the application presents only an option to checkout with digital cart 118, with no modification of digital cart 118 allowed. In some embodiments, the notification has a URL with the payload information pushed from video stream provider 122. In some examples, the URL is carried within an audio watermark in the content stream.

FIG. 2 depicts a sequence diagram of an illustrative process for securely communicating and authorizing transactions associated with digital content presented on a display device, in accordance with some embodiments of the present disclosure. In some embodiments, system 200 includes product provider 202 (e.g., an e-commerce provider such as Amazon, Alibaba, and eBay); video stream provider 204 (e.g., DirecTV, Dish, Altice, Comcast, Netflix, YouTube, Amazon Prime Video, and Disney Plus); display device 206 (e.g., a display device or television); authorization server 208 (e.g., a cloud-based digital wallet such as the Apple Wallet on an iPhone and the Google Wallet on Android phones); and user device 210 (e.g., a smart phone). In some embodiments, video stream provider 204 and product provider are the same entity or corporation with servers running in the same data center or otherwise under the control of the same entity. In some embodiments, a product provider may represent one or more of a merchant, a wholesaler, a supplier, a marketplace, a broker, a vendor, a retailer, a service provider, a platform, a seller, a promoter, or other offeror of goods or services.

At 212, video stream provider 204 receives a sign-in on display device 206. For example, the opening screen of a video service, upon first use, has two open boxes to provide an email or username, and a password, and display device 206 receives an input of an email or username and a password. In another example, the opening screen of a video service, upon first use, has the text “Please sign in to connect your cloud wallet” with two open boxes to provide an email or username, and a password, and display device 206 receives an input of an email or username and a password. At 214, video stream provider 204 connects to authorization server 208 using the sign in credentials that were received at 212. At 216, the authorization server 208 provides a sign-in token and a sign-in authorization signal to video stream provider 204 to indicate that a cloud wallet of a particular user or account is connected or linked to the video service. For example, the video service on display device 206 may display a screen with the text “Your cloud wallet has been connected,” (or similar) to notify the user that their cloud wallet and the video service are linked. At 218, video stream provider 204 sends a wallet authorization signal to the cloud wallet to ensure or confirm that the cloud wallet is connected to the video stream provider 204. At 220, authorization server 208 transmits an authorized wallet token to video stream provider 204 indicating that the video service is connected to the cloud wallet. In some embodiments, the video stream provider may use or include the authorized wallet token in later communications as part of the process to authorize transactions with a user device, as will be described in more detail hereinafter.

At 222, video stream provider 204 transmits scenes from video streams (e.g., video stream 103 of FIG. 1) to product provider 202. At 224, product provider 202 transmits or identifies products (e.g., product 104 of FIG. 1) and digital carts (e.g., digital cart 118 of FIG. 1) to video stream provider 204. At 226, video stream provider 204 associates the identified products with scenes of the video stream. In some embodiments, to associate the identified products with the scenes, video stream provider 204 and product provider 202 communicate to identify offerings (e.g., products and/or services) that can be presented in association with a content broadcast or stream. In some examples, video stream provider 204 then provides video to product provider 202, and product provider 202 then identifies what offerings to make available based on the video. In other examples, video stream provider 204 receives potential offerings from product provider 202, and video stream provider 204 determines what offerings to make available by analyzing the video content. At 228, video stream provider 204 receives a request to buy a product from a video stream at display device 206, as described further below with reference to FIG. 4.

At 230, video stream provider 204 transmits an NDEF message containing the digital cart, including a digital wallet token, the product, an identification of the product provider, and a short video clip (e.g., video clip 110 of FIG. 1), as well as a timer setting an expiration date on the digital cart, to authorization server 208. At 232, authorization server 208 invokes the mobile wallet (e.g., the Apple Wallet or Google Wallet) on user device 210 to display the digital cart with the product, the identification of the product provider, the short video clip, and the timer within the mobile wallet on the user device 210. In some embodiments, video stream provider 204 generates a cloud wallet token based on the credentials, one or more merchant identifiers based on product provider 202, and the product. In some examples, the cloud wallet token is stored in a specific uniform resource locator (URL) for the digital cart.

At 234, user device 210 renders the digital cart on the user device 210 and generates an option requesting biometric authorization, such as a face identification authorization or fingerprint identification authorization, to authorize the purchase of the digital cart. At 236, user device 210 uses its video player to play the short video clip within the mobile wallet. At 238, user device 210 deactivates the offer, e.g., by running the timer on the digital cart and removing the digital cart from display within the digital wallet on user device 210 when the timer runs out.

At 240, user device 210 transmits approval of the purchase of the digital cart to authorization server 208, for example, upon receiving biometric authorization to purchase the contents of the digital cart. At 242, authorization server 208 transmits approval of the purchase of the digital cart to video stream provider 204. At 244, video stream provider 204 removes the option to purchase the product associated with the scenes in the video stream. At 246, video service transmits approval of the purchase of the digital cart to product provider 202. At 248, product provider 202 adjusts their inventory records to account for the purchase of the products in the digital cart.

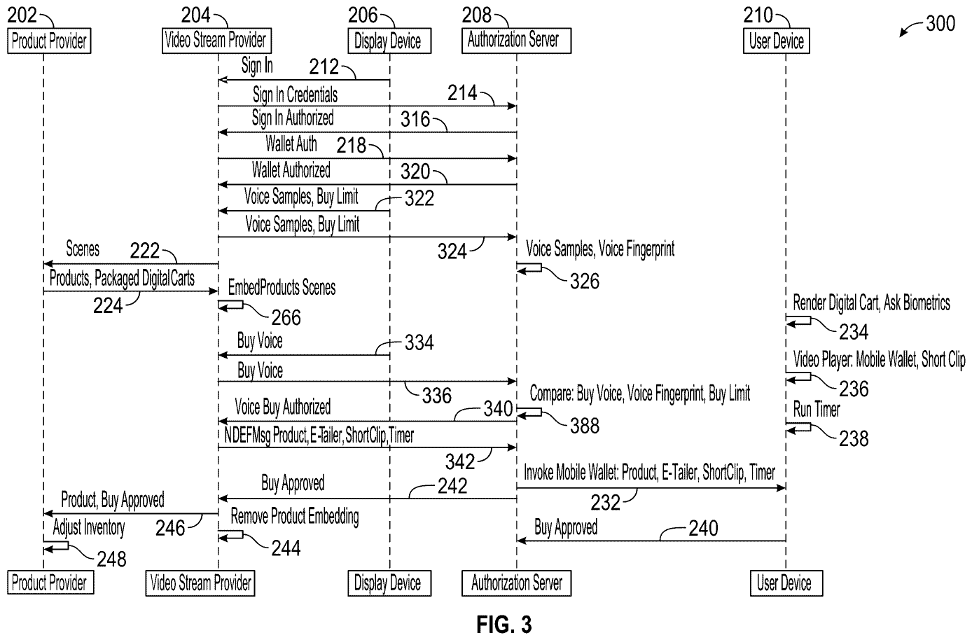

FIG. 3 is a sequence diagram of an illustrative process for securely using voice signature authentication, in accordance with some embodiments of the present disclosure. In some embodiments, system 300 includes product provider 202, video stream provider 204, display device 206, authorization server 208, and user device 210, e.g., a smart phone, as described further above with reference to FIG. 2.

In some embodiments, process steps 212-214 are described further above with reference to FIG. 2. At 316, the authorization server 208 provides a sign-in authorization signal to video stream provider 204 to indicate that the cloud identity wallet is connected at the video service. For example, the video service on display device 206 displays a screen with the text “Your cloud wallet has been connected.” In some embodiments, process step 218 is described further above with reference to FIG. 2. At 320, authorization server 208 transmits an authorization signal to video stream provider 204 indicating that the video service is connected to the cloud wallet.

In some embodiments, display device 206 has an embedded microphone. In some embodiments, display device 206 has a connected remote with an embedded microphone. In some embodiments, display device 206 is connected to or communicates with user device 210, which has an embedded microphone and natural language processing capabilities, e.g., a Digital Assistant, for example, a Google Home or an Amazon Alexa, or a smartphone. In some embodiments, display device 206 has natural language processing capabilities. In some implementations, the embedded microphone in display device 206 or the remote connected to display device 206 or in the connected device to display device 206 is configured to receive a voice command authorizing a purchase, e.g., “Buy it.” At 322, display device 206 receives a limited set of purchase words available to complete the transaction, e.g., “buy/done/approved,” wherein if the received command is not one of those words the purchase will not be authorized, and display device 206 sends the limited set of purchase words to video stream provider 204. In some embodiments, if the received command is ambiguously similar but not the same as a word in the limited set of purchase words, e.g., “Approve” instead of “Approved,” display device 206 generates a further prompt with user-selectable options to confirm or deny the purchase. At 324, video stream provider 204 sends the limited set of purchase words to authorization server 208 to aid in confirmation that the purchase was intended. In some examples, the voice command feature is disabled for purchases above a certain threshold, e.g., any purchase over $500. In some embodiments, the authorizing command is authenticated with an approved user signature. At 326, display device captures voice samples to create a voice fingerprint and/or voice signature during a setup phase and saves them at a cloud identity server, and once a received voice command is matched to the voice signature and/or voice fingerprint, the system will decide that the voice command is from a user that is authorized to complete the purchase, for instance, as noted by process step 338.

In some embodiments, process steps 222-226 are described further above with reference to FIG. 2. At 334, display device 206 receives a voice command to buy the product and transmits the voice command to buy the product to video stream provider 204. At 336, video stream provider 204 transmits the voice command to buy the product to authorization server 208. At 338, the cloud identity wallet compares the voice command to buy the product with the voice fingerprint and/or voice signature and the price of the product to the threshold price limit for purchases. At 340, cloud identity wallet 298 sends authorization of the voice command to buy the product through the video stream provider 204, indicating that the voice command is from an authorized user and can be processed for purchase. At 342, video stream provider 204 transmits an NDEF message containing the digital cart, including a digital wallet token, the product, an identification of the product provider, and a short video clip, as well as a timer setting an expiration date on the digital cart, to authorization server 208. At 232, authorization server 208 invokes the mobile wallet (e.g., the Apple Wallet or Google Wallet) on user device 210 to display the digital cart with the product, the identification of the product provider, the short video clip, and the timer within the mobile wallet on the user device 210. In some embodiments, video stream provider 204 generates a cloud wallet token based on the credentials, one or more merchant identifiers based on product provider 202, and the product. In some examples, the cloud wallet token is stored in a specific uniform resource locator (URL) for the digital cart. At 234, user device 210 renders the digital cart on the user device 210 and generates an option requesting biometric authorization, such as a face identification authorization, fingerprint identification authorization, or other biometric authentication techniques using the voice command and/or the voice fingerprint of the user to authorize the purchase of the digital cart. At 236, user device 210 uses its video player to play the short video clip within the mobile wallet.

At 238, user device 210 deactivates the offer, e.g., by running the timer on the digital cart and removing the digital cart from display within the digital wallet on user device 210 when the timer runs out. At 240, user device 210 transmits approval of the purchase of the digital cart to authorization server 208, for example, upon receiving biometric authorization to purchase the contents of the digital cart. At 242, authorization server 208 transmits approval of the purchase of the digital cart to video stream provider 204. At 244, video stream provider 204 removes the option to purchase the product associated with the scenes in the video stream. At 246, video service transmits approval of the purchase of the digital cart to product provider 202. At 248, product provider 202 adjusts their inventory records to account for the purchase of the products in the digital cart.

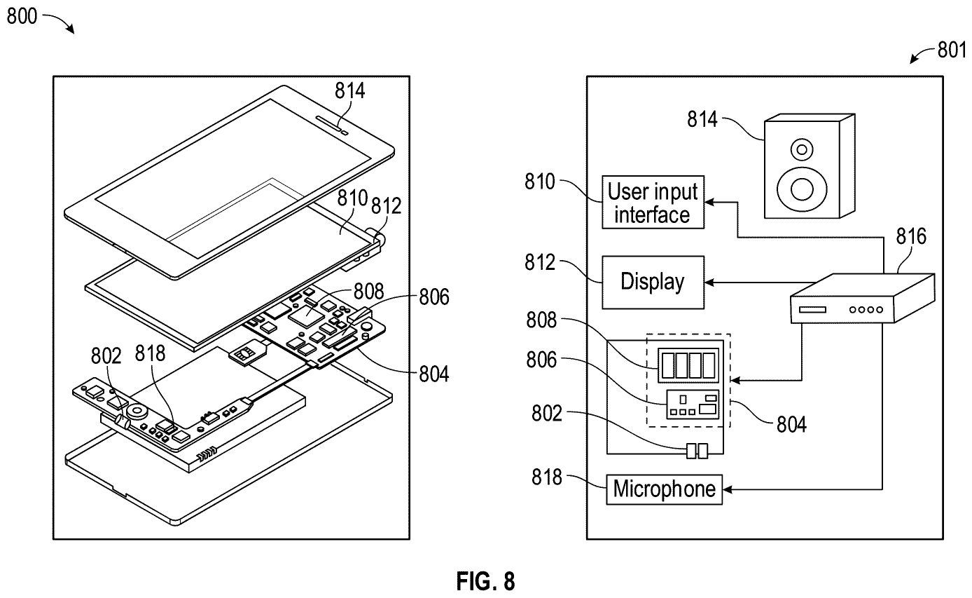

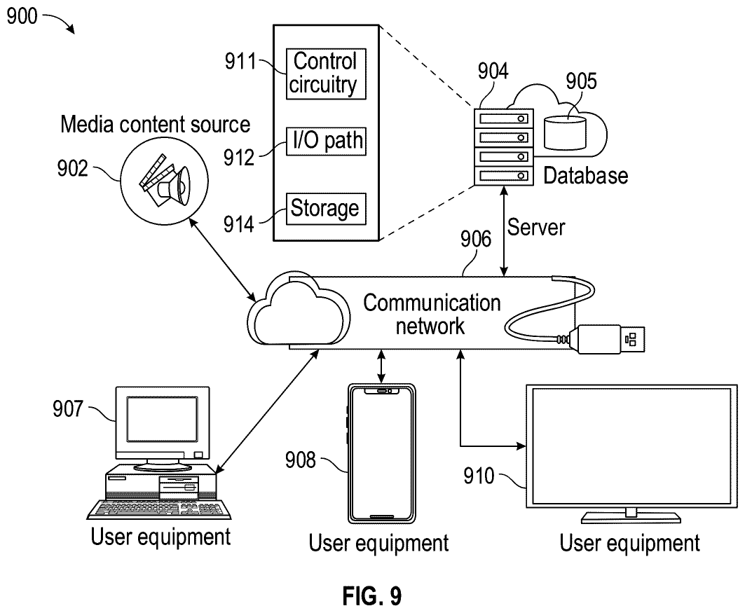

FIG. 4 is a flowchart of an illustrative process for securely communicating and authorizing transactions, in accordance with some embodiments of the present disclosure. In some embodiments, the steps outlined in process 400 are performed by one or more servers and devices of FIGS. 8 and 9. For example, non-transitory memories of one or more components of the server and devices of FIGS. 8 and 9, e.g., storage 914 and control circuitry 911, may store instructions that, when executed by the server and devices of FIGS. 8 and 9 (as described further below with reference to FIGS. 8 and 9) cause execution of the process depicted in FIG. 4. The actions and descriptions of FIG. 4 may be used with any other embodiment of this disclosure. In addition, the actions and descriptions described in FIG. 4 may be done in suitable alternative orders or in parallel to further the purposes of this disclosure.

At 402, control circuitry, for example, control circuitry 911 of FIG. 9, monitors for a selection of a first user interface option (e.g., first user interface option 104 of FIG. 1) to purchase a product (e.g., product 104 of FIG. 1) from a video stream (e.g., video stream 103 of FIG. 1) presented on a display device (e.g., display device 102 of FIG. 1). At 404, the control circuitry determines whether a selection of a first user interface option, e.g., first user interface option 106 of FIG. 1, to purchase a product during the video stream presented on the display device has been detected. In some embodiments, if a selection of a first user interface option to purchase a product from the video stream presented on the display device has been detected, process 400 proceeds to 406. In some implementations, if a selection of a first user interface option to purchase a product from the video stream presented on the display device has not been detected, process 400 returns to 402.

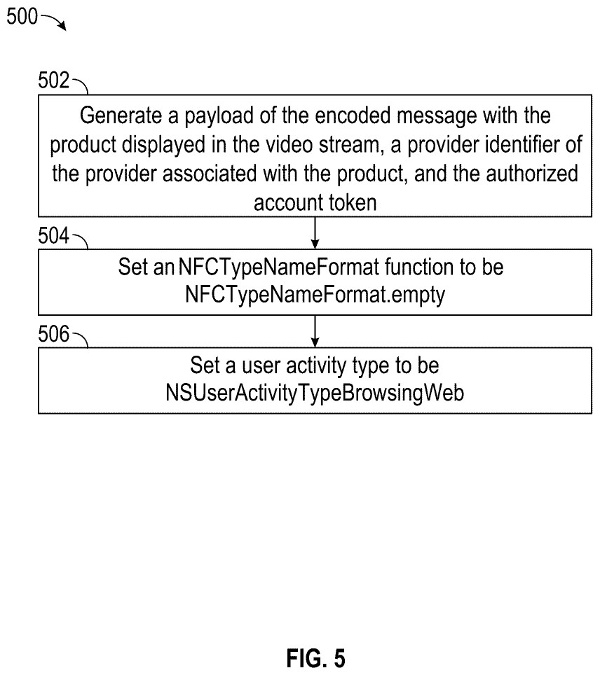

At 406, the control circuitry detects or identifies the product associated with the first user interface option to purchase. For instance, in some embodiments, the product is manually linked to the first user interface option using metadata and/or a manifest file, as described further above with reference to FIG. 1. In some embodiments, the product is linked to the first user interface option using a computer vision algorithm, as described further above with reference to FIG. 1. In some embodiments, the product is linked to the first user interface option using AI or ML image classification models, as described further above with reference to FIG. 1. At 408, the control circuitry creates a digital cart (e.g., digital cart 118 of FIG. 1) with the product and a video clip associated with the product (e.g., video clip 110 of FIG. 1). In some examples, the digital cart also contains a second product, related to the product. At 410, the control circuitry encodes details of the digital cart in a message that is used to communicate the digital cart offer to a user device for authorization to access or use an associated cloud wallet. In an example, the message is encoded as a near field communication (NFC) data exchange format message, as described further below with reference to FIG. 5. At 412, the control circuitry transmits, over a non-NFC network to a user device associated with the cloud wallet (e.g., user device 108 of FIG. 1) the digital cart encoded as the NFC data exchange format (NDEF) message by simulating an NFC connection over the non-NFC network. For instance, an NFC connection uses NFC protocols (as described further above with reference to FIG. 1) to authenticate a transaction. By simulating an NFC connection (using a network that is not part of the NFC communication) a transaction over, e.g., Wi-Fi, Bluetooth, IP, and/or other network connections, can adopt the same or similar security measures of an NFC transaction, along with the familiar interface of an electronic wallet from, e.g., Apple Pay or Google Pay. At 414, the control circuitry authorizes a transaction based on receiving, at the user device, a selection of a transaction authorization user interface option (e.g., transaction authorization user interface option 116 of FIG. 1) to purchase the contents of the digital cart.

FIG. 5 is a flowchart of an illustrative process for preparing an encoded message for transmission, in accordance with some embodiments of the present disclosure. In some embodiments, the steps outlined in process 500 are performed by one or more servers and devices of FIGS. 8 and 9. For example, non-transitory memories of one or more components of the server and devices of FIGS. 8 and 9, e.g., storage 914 and control circuitry 911, may store instructions that, when executed by the server and devices of FIGS. 8 and 9 (as described further below with reference to FIGS. 8 and 9) cause execution of the process depicted in FIG. 5. The actions and descriptions of FIG. 5 may be used with any other embodiment of this disclosure. In addition, the actions and descriptions described in FIG. 5 may be done in suitable alternative orders or in parallel to further the purposes of this disclosure.

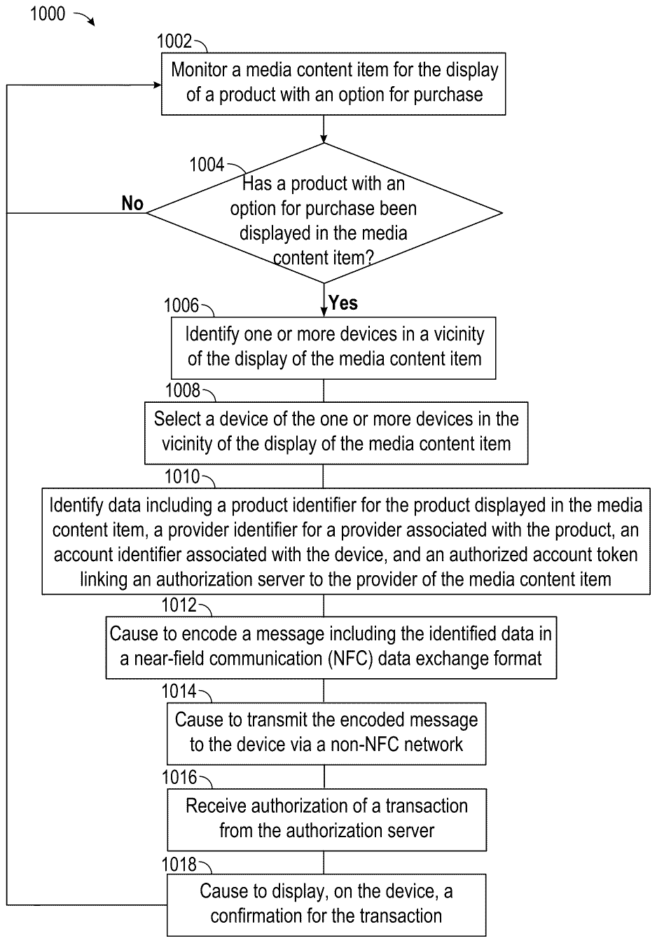

In some embodiments, process step 502 is executed following process step 1012 of process 1000, as described further below with reference to FIG. 10. At 502, control circuitry, for example, control circuitry 911 of FIG. 9, generates a payload of the encoded message. In some embodiments, the payload includes the product identifier, the provider identifier, and an account identifier token associated with the account identifier associated with the device. In some embodiments, the payload includes additional information, such as identifiers of other products or services, at least one media content item (e.g., a video clip), a timer parameter (e.g., that indicates an expiration of an offer), and/or other information or instructions. In some examples, contents of the encoded message, such as some or all of the payload, are identified by a specific uniform resource locator (URL) that is generated, for instance, by the video stream provider. At 504, the control circuitry sets an NFCTypeNameFormat function to be NFCTypeNameFormat. empty. At 506, the control circuitry sets a user activity type to be NSUserActivity TypeBrowsingWeb. In some embodiments, following process step 506, process 500 proceeds to process step 1014 of process 1000, as described further below with reference to FIG. 10.

FIG. 6 is a flowchart of an illustrative process for sharing the encoded message with a second device, in accordance with some embodiments of the present disclosure. In some embodiments, the steps outlined in process 600 are performed by one or more servers and devices of FIGS. 8 and 9. For example, non-transitory memories of one or more components of the server and devices of FIGS. 8 and 9, e.g., storage 914 and control circuitry 911, may store instructions that, when executed by the server and devices of FIGS. 8 and 9 (as described further below with reference to FIGS. 8 and 9) cause execution of the process depicted in FIG. 6. The actions and descriptions of FIG. 6 may be used with any other embodiment of this disclosure. In addition, the actions and descriptions described in FIG. 6 may be done in suitable alternative orders or in parallel to further the purposes of this disclosure.

In some embodiments, process step 602 is executed following process step 1014 of process 1000, as described further below with reference to FIG. 4. In some embodiments, at 602, control circuitry, for example, control circuitry 911 of FIG. 9, receives, at the device (e.g., user device 108 of FIG. 1) a selection of a user interface option (e.g., option to share the digital cart 114 of FIG. 1) to share the encoded message with the second device. At 604, the control circuitry transmits the encoded message as a similar NFC data exchange format (NDEF) message with the payload to a device via a messaging service. In some embodiments, a similar NFC data exchange format message with a similar payload or URL will be shared, and upon receiving the similar NFC data exchange format message, a similar mobile wallet invocation will be performed on the recipient device. In some embodiments, the messaging service is a text message service, a cloud messaging service, an electronic mail (email) service, or a social media application messaging service. In some examples, the control circuitry receives text, from the device sharing the cart, adding a message along with sharing the cart, e.g., “I loved this bag!” or “Check out this bag I am buying right now.”

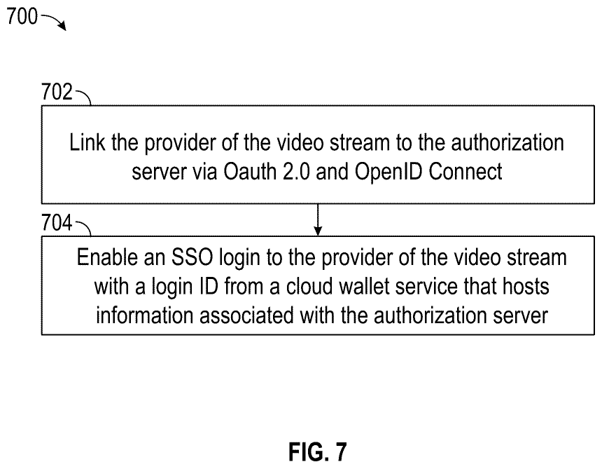

FIG. 7 is a flowchart of an illustrative process for receiving credentials for a video stream provider, in accordance with some embodiments of the present disclosure. In some embodiments, the steps outlined in process 700 are performed by one or more servers and devices of FIGS. 8 and 9. For example, non-transitory memories of one or more components of the server and devices of FIGS. 8 and 9, e.g., storage 914 and control circuitry 911, may store instructions that, when executed by the server and devices of FIGS. 8 and 9 (as described further below with reference to FIGS. 8 and 9) cause execution of the process depicted in FIG. 7. The actions and descriptions of FIG. 7 may be used with any other embodiment of this disclosure. In addition, the actions and descriptions described in FIG. 7 may be done in suitable alternative orders or in parallel to further the purposes of this disclosure.

In some embodiments, at 702, control circuitry, for example, control circuitry 911 of FIG. 9, links a provider of a video stream (e.g., video stream provider 122) to an authorization server (e.g., authorization server 126 of FIG. 1) via Oauth 2.0 and OpenID Connect. In some embodiments, the association is a one-time setup process per device and will not be repeated, e.g., for each video of the video service. At 704, the control circuitry enables an SSO login to the provider of the video stream with a login ID from a cloud wallet service that hosts information associated with the cloud wallet. In some embodiments, following process step 704, process 700 proceeds to process step 402 of FIG. 4. For example, for an OTT service (e.g., Tubi) if login with Apple is enabled, then when Tubi requests access to the Apple pay service (i.e., capability to send purchase transactions to Apple Wallet) the control circuitry pushes a notification to the device associated with the Apple Wallet. The notification allows the device associated with the Apple Wallet to accept enablement of this functionality. In this example, if the device associated with the Apple Wallet receives a refusal to enable payment functionality, login functionality will be on the OTT service but Apple Pay transactions will not be presented or authorized by the OTT service. In some embodiments, this setup process may be enabled for cable, satellite, over-the-air, and/or via other broadcast media by using, e.g., a login associated with a channel, app, platform, and/or other provider.

FIGS. 8 and 9 describe exemplary devices, systems, servers, and related hardware for sharing content through links via social media networks, in accordance with some embodiments of the present disclosure. FIG. 8 shows generalized embodiments of illustrative devices 800 and 801. For example, devices 800 and 801 may be smartphone devices, laptops, televisions (e.g., display device 102 and user device 108 of FIG. 1), smart televisions, streaming sticks, smart speakers, or voice assistants. Device 801 may include set-top box 816. Set-top box 816 may be communicatively connected to microphone 818, speaker 814, and display 812. In some embodiments, microphone 818 may receive voice commands. In some embodiments, display 812 may be a television display or a computer display. In some embodiments, set-top box 816 may be communicatively connected to user input interface 810. In some embodiments, user input interface 810 may be a remote-control device. Set-top box 816 may include one or more circuit boards. In some embodiments, the circuit boards may include processing circuitry, control circuitry, and storage (e.g., RAM, ROM, Hard Disk, Removable Disk, etc.). In some embodiments, the circuit boards may include an input/output path. More specific implementations of devices are discussed below in connection with FIG. 8. Each one of devices 800 and 801 may receive content and data via input/output (“I/O”) path 802. I/O path 802 may provide content (e.g., broadcast programming, on-demand programming, internet content, content available over a local area network (LAN) or wide area network (WAN), and/or other content) and data to control circuitry 804, which includes processing circuitry 806 and storage 608. Control circuitry 804 may be used to send and receive commands, requests, and other suitable data using I/O path 802, which may comprise I/O circuitry. I/O path 802 may connect control circuitry 804 (and specifically processing circuitry 606) to one or more communications paths (described below). I/O functions may be provided by one or more of these communications paths but are shown as a single path in FIG. 8 to avoid overcomplicating the drawing.

Control circuitry 804 may be based on any suitable processing circuitry such as processing circuitry 806. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 804 executes instructions for a media application stored in memory (i.e., storage 808). Specifically, control circuitry 804 may be instructed by the media application to perform the functions discussed above and below. In some implementations, any action performed by control circuitry 804 may be based on instructions received from the media application.

In client/server-based embodiments, control circuitry 804 may include communications circuitry suitable for communicating with a media application server or other networks or servers. The instructions for carrying out the above-mentioned functionality may be stored on a server (which is described in more detail in connection with FIG. 8). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 8). In addition, communications circuitry may include circuitry that enables peer-to-peer communication of devices, or communication of devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as media application data described above. Nonvolatile memory may also be used (e.g., to launch a boot-up routine and other instructions). Cloud-based storage, described in relation to FIG. 8, may be used to supplement storage 808 or instead of storage 808.

Control circuitry 804 may include video generating circuitry and tuning circuitry, such as one or more analog tuners, one or more MPEG-4 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 804 may also include scaler circuitry for upconverting and downconverting content into the preferred output format of device 800. Circuitry 804 may also include digital-to-analog converter circuitry and analog-to-digital converter circuitry for converting between digital and analog signals. The tuning and encoding circuitry may be used by device 800, 801 to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from device 800, the tuning and encoding circuitry (including multiple tuners) may be associated with storage 808.

A user may send instructions to control circuitry 804 using user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of each one of device 800 and device 601. For example, display 812 may be a touchscreen or touch-sensitive display. In such circumstances, user input interface 810 may be integrated with or combined with display 812. Display 812 may be one or more of a monitor, a television, a display for a mobile device, or any other type of display. A video card or graphics card may generate the output to display 812. The video card may be any processing circuitry described above in relation to control circuitry 804. The video card may be integrated with the control circuitry 804. Speakers 814 may be provided as integrated with other elements of each one of device 800 and device 801 or may be stand-alone units. The audio component of videos and other content displayed on display 812 may be played through the speakers 814. In some embodiments, the audio may be distributed to a receiver (not shown), which processes and outputs the audio via speakers 814.

The media application may be implemented using any suitable architecture. For example, it may be a stand-alone application wholly implemented on each one of device 800 and device 801. In such an approach, instructions of the application are stored locally (e.g., in storage 808), and data for use by the application is downloaded on a periodic basis (e.g., from an out-of-band feed, from an internet resource, or using another suitable approach). Control circuitry 804 may retrieve instructions of the application from storage 808 and process the instructions to rearrange the segments as discussed. Based on the processed instructions, control circuitry 804 may determine what action to perform when input is received from user input interface 810. For example, movement of a cursor on a display up/down may be indicated by the processed instructions when user input interface 810 indicates that an up/down button was selected.

In some embodiments, the media application is a client/server-based application. Data for use by a thick or thin client implemented on each one of devices 800 and 801 is retrieved on-demand by issuing requests to a server remote to each one of device 800 and device 801. In one example of a client/server-based guidance application, control circuitry 804 runs a web browser that interprets web pages provided by a remote server. For example, the remote server may store the instructions for the application in a storage device. The remote server may process the stored instructions using circuitry (e.g., control circuitry 804) to perform the operations discussed in connection with FIGS. 1-7 and 10-17.

In some embodiments, the media application may be downloaded and interpreted or otherwise run by an interpreter or virtual machine (run by control circuitry 804). In some embodiments, the media application may be encoded in the ETV Binary Interchange Format (EBIF), received by the control circuitry 804 as part of a suitable feed, and interpreted by a user agent running on control circuitry 804. For example, the media application may be an EBIF application. In some embodiments, the media application may be defined by a series of JAVA-based files that are received and run by a local virtual machine or other suitable middleware executed by control circuitry 804. In some of such embodiments (e.g., those employing MPEG-2 or other digital media encoding schemes), the media application may be, for example, encoded and transmitted in an MPEG-2 object carousel with the MPEG audio and video packets of a program.

FIG. 9 is a diagram of an illustrative streaming system, in accordance with some embodiments of the disclosure. Devices 907, 908, 910 (e.g., display device 102 and user device 108 of FIG. 1, which may be smartphone devices, laptops, televisions, smart television streaming sticks, smart speakers or voice assistants) may be coupled to communication network 906. Communication network 906 (e.g., network 120 of FIG. 1) may be one or more networks including the internet, a mobile phone network, mobile voice or data network (e.g., a 4G or LTE network), cable network, public switched telephone network, or other types of communication network or combinations of communication networks. Paths (e.g., depicted as arrows connecting the respective devices to the communication network 906) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 9 to avoid overcomplicating the drawing.

Although communications paths are not drawn between devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The devices may also communicate with each other directly through an indirect path via communication network 906.

System 900 includes a media content source 902 and a server 904, which may comprise or be associated with database 905. Communications with media content source 902 and server 904 may be exchanged over one or more communications paths but are shown as a single path in FIG. 9 to avoid overcomplicating the drawing. In addition, there may be more than one of each of media content source 902 and server 904, but only one of each is shown in FIG. 9 to avoid overcomplicating the drawing. If desired, media content source 902 and server 904 may be integrated as one source device.

In some embodiments, server 904 may include control circuitry 911 and a storage 914 (e.g., RAM, ROM, Hard Disk, Removable Disk, etc.). Server 904 may also include an input/output path 912. I/O path 912 may provide device information, or other data, over a local area network (LAN) or wide area network (WAN), and/or other content and data to the control circuitry 911, which includes processing circuitry, and storage 914. The control circuitry 911 may be used to send and receive commands, requests, and other suitable data using I/O path 912, which may comprise I/O circuitry. I/O path 912 may connect control circuitry 911 (and specifically processing circuitry) to one or more communications paths.

Control circuitry 911 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 911 executes instructions for an emulation system application stored in memory (e.g., the storage 914). Memory may be an electronic storage device provided as storage 914 that is part of control circuitry 911.

Server 904 may retrieve guidance data from media content source 902, process the data as will be described in detail below, and forward the data to devices 907 and 910. Media content source 902 may include one or more types of content distribution equipment including a television distribution facility, cable system headend, satellite distribution facility, programming sources (e.g., television broadcasters, such as NBC, ABC, HBO, etc.), intermediate distribution facilities and/or servers, internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 902 may be the originator of content (e.g., a television broadcaster, a Webcast provider, etc.) or may not be the originator of content (e.g., an on-demand content provider, an internet provider of content of broadcast programs for downloading, etc.). Media content source 902 may include cable sources, satellite providers, on-demand providers, internet providers, over-the-top content providers, or other providers of content. Media content source 902 may also include a remote media server used to store different types of content (including video content selected by a user), in a location remote from any of the client devices. Media content source 902 may also provide metadata that can be used to identify important segments of media content as described above.

Client devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices (such as, e.g., server 904), which may be located centrally or at distributed locations, that provide cloud-based services to various types of users and devices connected via a network such as the internet via communication network 906. In such embodiments, devices may operate in a peer-to-peer manner without communicating with a central server.

FIG. 10 is a flowchart of an illustrative process for securely communicating and authorizing transactions, in accordance with some embodiments of the present disclosure. In some embodiments, the steps outlined in process 1000 are performed by one or more servers and devices of FIGS. 8 and 9. For example, non-transitory memories of one or more components of the server and devices of FIGS. 8 and 9, e.g., storage 914 and control circuitry 911, may store instructions that, when executed by the server and devices of FIGS. 8 and 9 (as described further below with reference to FIGS. 8 and 9) cause execution of the process depicted in FIG. 10. The actions and descriptions of FIG. 10 may be used with any other embodiment of this disclosure. In addition, the actions and descriptions described in FIG. 10 may be done in suitable alternative orders or in parallel to further the purposes of this disclosure.

At 1002, control circuitry, for example, control circuitry 911 of FIG. 9, monitors a media content item for the display of a product with an option for purchase. In some embodiments, the media content item is a video stream (e.g., video stream 103 of FIG. 1). In some embodiments, the media content item is an audio stream, and the display of the product is a mention of a product. The media content item may be or any type of media content item that otherwise displays or discusses products. In some examples, the media content item is being displayed on a display device, e.g., display device 102 of FIG. 1. In some embodiments, the product is product 104 of FIG. 1. At 1004, the control circuitry determines whether a product with an option for purchase has been displayed in the media content item. In some examples, the control circuitry determines whether a product with an option for purchase has been displayed in the media content item by determining whether an image depicting a product in the media content item have been linked to a product provider (e.g., product provider 124 of FIG. 1) offering the product for sale, as described further above with reference to FIG. 1. In some embodiments, if a product with an option for purchase has not been displayed in the media content item, process 1000 returns to 1002. In some implementations, if a product with an option for purchase has been displayed in the media content item, process 1000 proceeds to 1006.

At 1006, the control circuitry identifies one or more devices in a vicinity of the display of the media content item. In some embodiments, the control circuitry identifies devices based on the devices having completed a prior sign-in, authorization, or accepting of permissions to receive messages from nearby devices. In some examples, the prior sign-in is one of a login with a username and password to the provider of the media content item. One such example is described further above with reference to FIG. 7. In some examples, the prior sign-in is an identifier (such as a phone number or email address) and the provider of the media content item looks up and finds a cloud wallet associated with the identifier; the provider of the media content item then queries an authorization server (e.g., authorization server 126 of FIG. 1) using the identifier to link digital wallet information to the provider of the media content item. In some embodiments, the identified devices are not already logged into the provider of the media content item. For example, the control circuitry identifies the one or more devices using one or more cameras and/or microphones attached to the display device displaying the media content item to capture images of nearby devices. In another example, the control circuitry identifies the one or more devices by detecting devices connected to the same wireless network, e.g., a Wi-Fi network, a Bluetooth network, or a cellular data network, as the display device displaying the media content item. In another example, the control circuitry identifies the devices by detecting devices that have scanned a QR code on the display device. In another example, the control circuitry identifies the devices by detecting devices that have a particular application downloaded. In other examples, the control circuitry identifies the devices using one or more sensors, such as a fingerprint sensor on the devices, or one or more of Radio Frequency Identification (RFID), NFC, or Channel State Information (CSI) wireless sensing. At 1008, the control circuitry selects a device of the one or more devices in the vicinity of the display of the media content item. In some embodiments, the control circuitry selects all of the one or more devices in the vicinity of the display of the media content item. In some examples, different devices in the vicinity of the display of the media content item are each provided with unique offers, e.g., based on the type of device, information stored in a user profile associated with the device, and/or other data (such as browsing history or purchase history) stored on the device. In some examples, the control circuitry selects only the device closest in physical proximity to the display device displaying the media content item. In some embodiments, the control circuitry selects devices from one or more devices by sending a pop-up message to the devices with a user interface option to give the display device permission to share further content with the nearby devices. In some examples, the pop-up message is sent over the wireless network that the display device and the one or more devices are all connected to. In some examples, the pop-up message is sent over a non-NFC network, as described further above with reference to FIG. 1. In some embodiments, the selected device is user device 108 of FIG. 1.

At 1010, the control circuitry identifies data including a product identifier for the product displayed in the media content item, a provider identifier for a provider associated with the product, an account identifier associated with the device, and an authorized account token linking an authorization server to the provider of the media content item. In some implementations, the control circuitry determines the authorized account token by determining an identifier of the provider of the media content item associated with the transaction offer and linked to the authorization server. In an example, the authorized account token is specified as AuthorizedDigitalWalletToken. In some embodiments, the authorization server is authorization server 126 of FIG. 1. At 1012, the control circuitry causes encoding of a message including the identified data in an NFC data exchange format (as described further above with reference to FIG. 5). For example, the provider of the media content item initiates a transaction with the selected device by generating a message that is communicated through a cloud wallet associated with the authorization server. At 1014, the control circuitry causes transmission of the encoded message to the device via a non-NFC network (e.g., network 120 of FIG. 1), for example, by simulating an NFC connection over the non-NFC network. In some embodiments, simulating the NFC connection over the non-NFC network involves transmitting the encoded message the same way data would be transmitted using an NFC tap (described further above with reference to FIG. 1), but without tapping the device receiving the encoded message to a special hardware piece on the display device. For example, an NFC connection uses NFC protocols (as described further above with reference to FIG. 1) to authenticate a transaction. By simulating an NFC connection (using a network that is not part of the NFC communication) a transaction over, e.g., Wi-Fi, Bluetooth, IP, and/or other network connections, can adopt the same or similar security measures of an NFC transaction, along with the familiar interface of an electronic wallet from, e.g., Apple Pay or Google Pay.

In some embodiments, after the device receives the message, the authorization server generates a mobile wallet invoice for display on a user interface of the device based on the information from the encoded message. In some embodiments, the encoded message does not include all of the information necessary to render the mobile wallet invoice on the user interface of the device. In some examples, the device has a template or instructions, e.g., provided via an application, by the provider of the media content item, or by the authorization server to instruct the device on rendering of the mobile wallet invoice. In some embodiments, this provided template is a URL.

At 1016, the control circuitry receives authorization of a transaction from the authorization server. In some embodiments, the authorization is based at least in part on biometric identification, with the provider of the media content item (e.g., video stream provider 122 of FIG. 1) receiving the biometric identification data and transmitting the data to the authorization server. In some embodiments, the biometric identification data is facial identification authorization, fingerprint identification authorization, or voice identification authorization, as described further above with reference to FIG. 3. In some embodiments, the biometric data is received by the provider of the media content item prior to the control circuitry causing transmission of the encoded message to the device via a non-NFC network, and the data is later used to authorize the purchase. In some examples, the biometric data is received by the provider of the media content item after the control circuitry causes transmission of the encoded message to the device via the non-NFC network. At 1018, the control circuitry causes to display, on the device, a confirmation for the transaction, e.g., a user interface with the words “Thank you for your purchase,” a picture of the ordered product or products, an order number, and a link for tracking the shipment of the purchase.

The foregoing is merely illustrative of the principles of this disclosure and its various embodiments. Various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations and modifications thereof, which are within the spirit of the following claims.

1. A method comprising:
identifying one or more devices in a vicinity of a display of a video stream, wherein a product is displayed in the video stream and the video stream is provided by a video stream provider;
selecting a device of the one or more devices in the vicinity of the display of the video stream;
identifying data to cause encoding of a message in a near-field communication (NFC) data exchange format, the message comprising: (a) a product identifier for the product displayed in the video stream, (b) a provider identifier for a provider associated with the product, (c) an account identifier that identifies the device that will engage in communication with the display of the video stream, and (d) an authorized account token linking an authorization server to the video stream provider;
causing to transmit the encoded message to the selected device via a non-NFC network;
receiving authorization of a transaction from the authorization server; and
causing to display, on the selected device, a confirmation for the transaction.

2. The method of claim 1, wherein:
a payload of the encoded message comprises the product identifier, the provider identifier, and an account identifier token associated with the account identifier associated with the device; and
the encoded message comprises:
a name function set to be indicative of an empty value; and
a user activity type set to be indicative of web browsing.

3. The method of claim 2, wherein contents of the payload are identified by a uniform resource locator (URL).

4. The method of claim 2, further comprising:
receiving, at the selected device, a selection of a user interface option to share the encoded message with a second device; and
transmitting the encoded message with the payload to the second device via a messaging service.

5. The method of claim 1, wherein the encoded message comprises:
a video clip, wherein the video clip is personalized based on one or more of:
stored user preferences for a user account associated with the selected device;
products in the video stream;
people in the video stream;
the provider of the video stream;
the provider associated with the product; or
inventory levels at the provider associated with the product.

6. The method of claim 5, further comprising receiving a selection of a user interface option on the selected device to play or pause the video clip on the selected device.

7. The method of claim 1, wherein the identified data further comprises a second product related to the product, and wherein the product and the second product are chosen based on one or more of:
products in the video stream;
other products not in the video stream related to the products in the video stream;
products associated with people in the video stream;
stored user preferences for a user account associated with the selected device;
the provider associated with the product; or
inventory levels at the provider associated with the product.

8. The method of claim 7, wherein the product and the second product cannot be modified or removed from the encoded message via a user interface of the selected device.

9. The method of claim 1, wherein the identifying the data comprising the authorized account token linking the authorization server to the provider of the video stream comprises:
linking the provider of the video stream to the authorization server via OAuth 2.0 and OpenID Connect; and
enabling a Single Sign On (SSO) login to the provider of the video stream with a login ID from a cloud wallet service that hosts information associated with the authorization server.

10. The method of claim 1, wherein the encoded message expires and is removed from the selected device after a predetermined time period.

11. The method of claim 1, wherein the identifying data further comprises continuing to display the video stream without displaying a webpage related to the product.

12. The method of claim 1, wherein the receiving the authorization of the transaction from the authorization server is based at least in part on biometric identification, and wherein the video stream provider receives biometric identification data and transmits the data to the authorization server.

13. The method of claim 1, wherein the identifying the one or more devices in the vicinity of the display of the video stream display comprises one or more of identifying the one or more devices with a camera or identifying the one or more devices connected to the same wireless network as the display.

14. A system comprising:
control circuitry configured to:
identify one or more devices in a vicinity of a display of a video stream, wherein a product is displayed in the video stream and the video stream is provided by a video stream provider;
select a device of the one or more devices in the vicinity of the display of the video stream;
identify data to cause encoding of a message in a near-field communication (NFC) data exchange format, the message comprising: (a) a product identifier for the product displayed in the video stream, (b) a provider identifier for a provider associated with the product, (c) an account identifier that identifies the device that will engage in communication with the display of the video stream, and (d) an authorized account token linking an authorization server to the video stream provider;
cause to transmit the encoded message to the selected device via a non-NFC network;
receive authorization of a transaction from the authorization server; and display circuitry configured to:
cause to display, on the selected device, a confirmation for the transaction.

15. The system of claim 14, wherein:
a payload of the encoded message comprises the product identifier, the provider identifier, and an account identifier token associated with the account identifier associated with the device; and
the encoded message comprises:
a name function set to be indicative of an empty value; and
a user activity type set to be indicative of web browsing.

16. The system of claim 15, wherein contents of the payload are identified by a uniform resource locator (URL).

17. The system of claim 15, wherein the control circuitry is further configured to:
receive, at the selected device, a selection of a user interface option to share the encoded message with a second device; and
transmit the encoded message with the payload to the second device via a messaging service.

18. The system of claim 14, wherein the encoded message comprises:
a video clip, wherein the video clip is personalized based on one or more of:
stored user preferences for a user account associated with the selected device;
products in the video stream;
people in the video stream;
the provider of the video stream;
the provider associated with the product; or
inventory levels at the provider associated with the product.

19. The system of claim 18, further comprising input/output circuitry configured to receive a selection of a user interface option on the selected device to play or pause the video clip on the selected device.

20. The system of claim 14, wherein the identified data further comprises a second product related to the product, and wherein the product and the second product are chosen based on one or more of:
products in the video stream;
other products not in the video stream related to the products in the video stream;
products associated with people in the video stream;
stored user preferences for a user account associated with the selected device;
the provider associated with the product; or
inventory levels at the provider associated with the product.

21.-65. (canceled)
